(19) United States
(12) Patent Application Publication
(10) Pub. No.: US 2020/0346853 A1
(43) Pub. Date: Nov. 5, 2020

(54) REUSABLE, WEATHER RESISTANT, MAGGOT PREVENTING TRASH CAN COVER WHICH SECURES TO TRASH CAN VIA INTERIOR STRAPS

(71) Applicants: Yolanda Thompson-Buist, Hoogezand (NL); Luitje Albert Buist, Hoogezand (NL)

(72) Inventors: Yolanda Thompson-Buist, Hoogezand (NL); Luitje Albert Buist, Hoogezand (NL)

(21) Appl. No.: 16/398,409

(22) Filed: Apr. 30, 2019

(51) Int. Cl. B65F 1/16; B65F 1/14

(52) U.S. Cl. CPC B65F 1/16; B65F 1/1473

(57) ABSTRACT

The present invention is a reusable, weather resistant trash can cover with straps located on the inside, dome portion which enable it to attach to the trash can lid handles and back handle of the body of the trash can. The invention is one piece, does not have holes nor slits, has an elastic or draw string peripheral edge and elongated walls which extend down the sides of the trash can to allow for complete coverage of the trash can's top portion even when the lid is ajar.

### CROSS-REFERENCE TO RELATED APPLICATIONS

Not Applicable.

### FEDERALLY SPONSORED RESEARCH OR DEVELOPMENT

Not Applicable.

### INCORPORATION BY REFERENCE OF MATERIAL PRESENTED ON A COMPACT DISC

Not Applicable.

### BACKGROUND OF THE INVENTION

Various types of container opening covers are known however what is needed is a flexible, reusable, weather resistant, covering for the entire top portion of a trash can, lid included, which does not have holes or slits, has straps located on interior of the dome which attach to the trash can lid and trash can handle while having a body which extends down the sides of the top portion of the trash can for covering of the opening created by overflowing trash for the purpose of helping to reduce and prevent the entrance of flies, fly eggs and thus maggots in the trash can.

### FIELD OF INVENTION

The present invention relates to a flexible, reusable, weather resistant, trash can cover which extends down the sides of the top portion of a trash can, attaches to the trash can lid and handle via straps, inside the dome, to prevent flies, fly eggs and maggots from entering the trash can even when the accumulation of trash causes the lid to be ajar. The straps securing the cover to the lid handles and the handle located at the upper back prevent the cover from falling into the garbage truck when the trash is emptied by the city or municipality or blowing away in windy weather. The cover has an elastic or drawstring peripheral edge which allows it to fit different sizes of the most commonly used trash cans today.

### SUMMARY OF THE INVENTION

The purpose of the present invention, described subsequently in further detail, features a flexible, reusable, weather resistant trash can cover with interior straps that secure it to the trash can handle and lid handles when present. The inventive cover is configured for placement over top of an entire trash can, lid included and extends down the sides of the trash can to help curtail the entrance of flies, fly eggs and maggots in the trash can. To achieve the purpose the cover is one piece, without holes or slits and is made from choice performance, flexible, weather resistant material. The edge has elastic or a drawstring which creates a tight fit against the body of the trash can preventing fly entrance. There are two sets of straps located on the inside dome of the cover; one set at the front which secures the cover to lid handles if and when lid handles are present and the other set of straps located at the back which secures the cover to the trash can handle.

### BRIEF DESCRIPTION OF THE DRAWINGS

FIG. 1 Upright, interior view of preferred embodiment

FIG. 2 Downward facing view of preferred embodiment

FIG. 3 Image of preferred embodiment in use

FIG. 4 Image of preferred embodiment in use

FIG. 5 Image of alternative embodiment

FIG. 6 Image of alternative embodiment in use

### DETAILED DESCRIPTION OF THE INVENTION

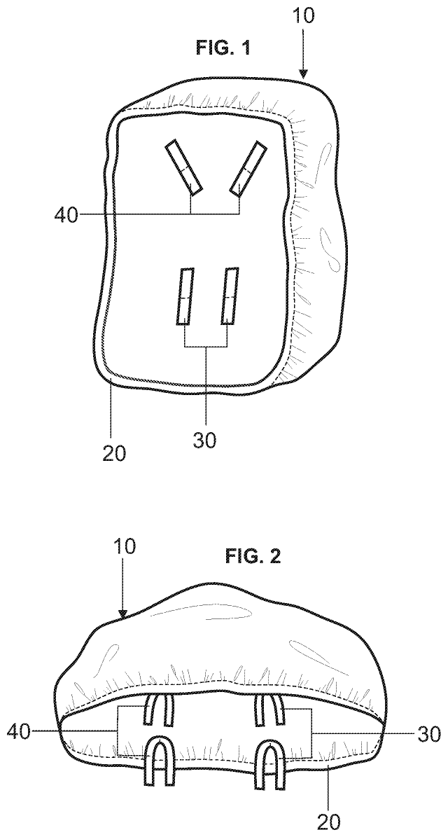

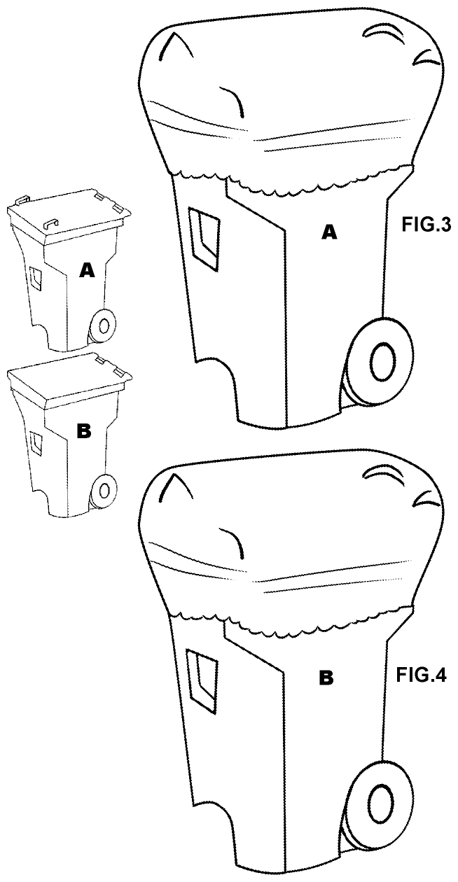

With reference now to the drawings and in particular FIG. 1 through FIG. 4 thereof, a preferred embodiment of the trash can cover referenced by number 10 is shown. The present invention 10 is a flexible, reusable, weather resistant, washable trash can cover which is dome in shape, with elongated, continuous walls configured specifically for secured placement on example trash cans A, B and is comprised of two sets of interior straps 30 and 40 and has an elastic or drawstring peripheral 20 to allow for a tight fit to the body of different size trash cans.

Trash cans often have foul smells, especially during hotter summer months thus attracting flies. Worldwide in most cities, counties and municipalities residential trash cans are emptied once a week. In a weeks time trash sitting with a strong, foul odor will attract flies. Flies will enter the trash can to lay eggs or lay their eggs on the rim and lid when unable to enter. A female fly that manages to enter a trash can through a crack or opening can lay up to 500 eggs in a 3 day period inside the trash can or on its rim and lid. The eggs laid inside, on the rim and the lid of the trash turn into larvae, maggots within a 24 hour period. The maggots on the rim and lid find their way inside through the small crack present between the lid and trash can. It only takes 24 hours for these hundreds of eggs to turn into maggots and thus on a weekly, semi-monthly and monthly basis, trash cans can be overrun with maggots on any given day.

The trash can cover 10 prevents flies from entering and laying eggs in the trash can by covering the entire top portion of the trash can, lid included. The trash can cover 10 is secured to the trash can by the interior back set of attachments 40 which can be straps that tie, snap fasten, hook and eye fastened around the handle. When lid handles are present then the front attachments 30 will be secured to the lid as well by interior strap ties, snap fastener, or hook and eye fastener. The front and back attachments 30, 40 are sewn to the interior dome portion of the trash can cover 10 enabling the trash can cover 10 to remain as one piece, without any holes or slits through which flies, eggs or larvae can attach to or enter the top portion of the trash can. The elastic or drawstring peripheral edge 20 of the trash can cover 10 enables it to fit tightly around the trash can body once again preventing flies, their eggs and eventually maggots from gaining access to the trash can, despite whatever foul odor present.

The elastic or drawstring edge 20 in conjunction with the front and back attachments 30, 40 create an easy and manageable way for an individual to open the trash can lid without having to worry about the trash can cover 10 falling off or blowing away, nor mistakenly falling into the trash can truck on collection day. When the trash is collected by the city, the cover 10 remains on the trash can and is easily pulled up by the workers if manually handled or in the case of automated trucks the weight of the trash on the lid when upside down will cause the elastic edge 20 to release the cover 10 from the rim of the trash can allowing the trash to fall unencumbered into the truck. The trash can cover 10 during automated and manually dumping will remain secured to the trash can due to the back attachment straps 40 and front lid attachment straps 30 if and when the lid has handles.

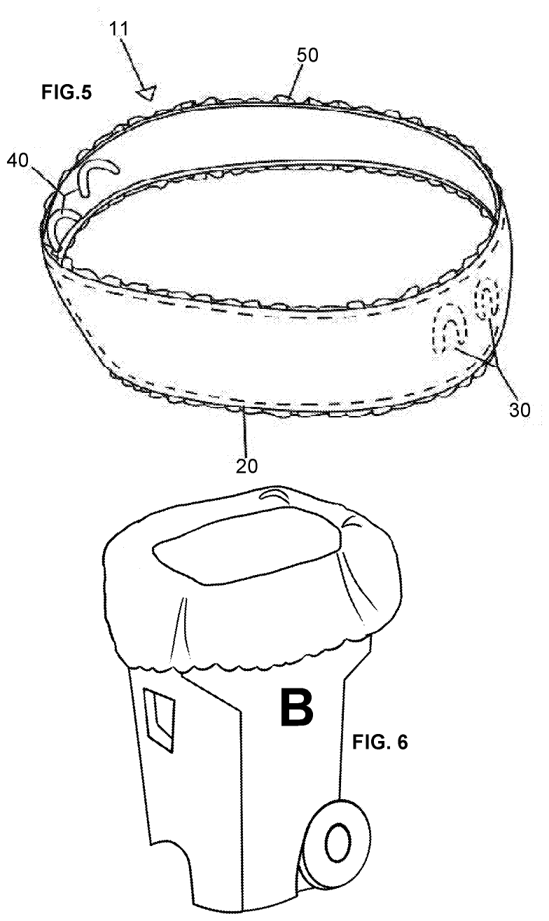

An alternative embodiment of the trash can cover 10 is one in which the reusable, choice performance weather resistant material is replaced with a disposable material which can be thrown away each time the trash can is emptied. Another alternative embodiment of the trash can cover 10 is one in which no inside attachments are present to secure the trash can cover to the handle(s). A third alternative embodiment of the trash can cover 10 is one in which a disposable material is used and there are no attachments to secure it to the trash can handles. A fourth embodiment 11 of the trash can cover 10 is shown in FIG. 5. FIG. 6 shows this alternative embodiment 11 in use. This fourth embodiment 11 is one in which the dome portion of the cover is removed, replaced by a center elastic 50 for prevention of flies into the cover since the trash can cover becomes a band which wraps around the opening and this may still attach to handles or not. Those skilled in the art will recognize that the scope of this invention 10, as stated in the claims, is its ability to cover the trash can, any crack at the lid opening, attach to the trash can handle without there being any opening through which flies or maggots can enter and it's ability to extend down the side of the trash can allowing for overflow as well as its easy use by city, municipality workers and home owners.

What is claimed is:

1. A reusable, weather resistant covering for the entire top portion of a trash can, lid included, which does not have holes or slits comprising:
a flexible weather resistant material that is dome in shape, with elongated, continuous walls extending down the sides of the top portion of the trash can with an elastic or drawstring peripheral edge, interior straps securing it to the trash can handle and lid handles when present;
wherein the flexible weather resistant material is durable and reusable;
wherein the elastic or drawstring peripheral edge enables the cover to fit tight against the body of the trash can preventing entry of flies and maggots, while also allowing it to fit different size and shape trash cans due to its ability to stretch at the periphery;
wherein the straps are interior and can be but not limited to strap ties which secure the cover to the trash can and lid by tying around the handles or snapping together around the handles with straps having snap fasteners, or hooking together around the handles with straps having hook and eye or any other fastening system;
wherein the size of the cover is larger than the container to allow for adjustability to container size and for overflowing containers with ajar lids.

2. Alternative embodiments such as: a trash can cover which does not have straps to secure it to a trash can handles and is created from either reusable or disposable material and a disposable covering for the entire top portion of a trash can, lid included, which does not have holes or slits comprising:
a disposable material which extends down the sides of the top portion of the trash can with an elastic or drawstring peripheral edge and interior straps which secure it to the trash can handle;
wherein the cover is created from a cheaper, less sturdy material which can be disposed of weekly, bi-monthly or monthly;
wherein the attachments such as but not limited to strap ties are located inside the cover and attach to the handles by tying;
wherein the container cover size is larger than the container to allow for adjustability of the container size and for overflowing containers with ajar lids.

3. An alternative embodiment of the cover which has no crown and is band like in design;
wherein the band has a central and peripheral edge: an inside and outside edge with adjustability due to elastic or drawstring;
wherein the band attaches to the trash can handles with interior straps;
wherein the band is wide, thus extending down the top portion of the trash can to allow for overflow of the trash can;
wherein the band can be created from choice performance reusable material or disposable material.
